(19) United States
(12) Patent Application Publication
(10) Pub. No.: US 2013/0110781 A1
(43) Pub. Date: May 2, 2013

(54) SERVER REPLICATION AND TRANSACTION COMMITMENT

(71) Applicants: Wojciech Golab, Mountain View, CA (US); Nathan Lorenzo Binkert, Redwood City, CA (US); Indrajit Roy, Mountain View, CA (US); Mehul A. Shah, Saratoga, CA (US); Bruce Walker, Rolling Hills Estates, CA (US)

(72) Inventors: Wojciech Golab, Mountain View, CA (US); Nathan Lorenzo Binkert, Redwood City, CA (US); Indrajit Roy, Mountain View, CA (US); Mehul A. Shah, Saratoga, CA (US); Bruce Walker, Rolling Hills Estates, CA (US)

(21) Appl. No.: 13/285,755

(22) Filed: Oct. 31, 2011

(51) Int. Cl. G06F 7/00

(52) U.S. Cl. 707/638; 707/703; 707/684; 707/E17.005; 707/E17.032

(57) ABSTRACT

An embodiment provides a method for server replication and transaction commitment. The method includes receiving a transaction from a client node at one or more memory nodes, each memory node comprising a number of replicas, and determining, for each one of the replicas, whether the replica is able to commit the transaction. The method also includes sending a response from each of the replicas to a consensus node, wherein the consensus node is configured to record whether the response is a commit response. The method further includes committing the transaction if, at each memory node, a quorum of the replicas is able to commit the transaction, and aborting the transaction otherwise.

### BACKGROUND

Many modern businesses may benefit from storage infrastructure that supports modern-scale applications by reacting quickly and efficiently to changing conditions. Examples of such modern-scale applications include financial trading, electronic auctioning, social networking, and multi-player gaming. These types of modern-scale applications benefit from storage infrastructure that offers high availability, high scalability, and low latencies. In addition, transactional consistency may be important because these types of applications are often being retuned and re-engineered to meet users' needs. Transactions may also be important when the workload itself is inherently transactional, such as when a financial customer moves money from one account to another.

Traditional solutions to this problem, such as databases, provide transactions and continuous operation, but have limited scalability and high latencies. For example, databases include features that limit their scalability and also have limited response times because disks are the primary storage solution for databases. In addition, traditional file systems and block storage solutions have similar problems, lack transactions, and also provide interfaces that are not well suited for modern-scale applications. Therefore, there is a recent push to use new and simpler storage solutions or database management systems, which scale well and offer more streamlined key-value interfaces that are better suited to modern-scale applications. Unfortunately, most of these storage solutions sacrifice consistency for improved availability and, hence, lack transactions.

Memory for a computer system may include any form of electronic, magnetic, quantum-mechanical, or optical storage solution. However, it is generally divided into different categories based in part upon speed and functionality. One category is mass storage, which typically includes permanent, non-volatile memory storage solutions. Mass storage is generally understood to include relatively cheap, slow, and large-capacity devices, such as hard drives, tape drives, optical media, and other mass storage devices. The primary object of mass storage devices is to store an application or data until it is required for execution. To prevent loss of data, data is often replicated between two or more redundant storage devices. Replication introduces a degree of latency to the storage system. As used herein, the term “latency” refers to the delay between the time at which a request is made from a client and a response is received from the service, which may be composed of multiple servers. Mass storage devices typically provide a computer system with memory storage ranging to the tens of terabytes and operate with access times generally in excess of one millisecond. However, because mass storage typically involves high latencies, the use of mass storage may not be sufficient for modern-scale applications, which require fast reaction times.

A second general memory category is application memory, or main memory, which is intended to permit quick access for processing and is typically connected by a memory bus directly to the computers processor. In contrast to the relatively slow mass storage, main memory generally includes relatively fast, expensive, volatile random access memory (RAM) with access times generally less than one hundred nanoseconds. However, due to the volatile nature of main memory, many applications utilizing main memory rely on a continuous power supply to maintain functionality.

### BRIEF DESCRIPTION OF THE DRAWINGS

Certain embodiments are described in the following detailed description and in reference to the drawings, in which:

FIG. 1 is a block diagram of a server replication and transaction commitment system, in accordance with embodiments;

FIG. 2 is a process flow diagram showing a method for transaction commitment, in accordance with embodiments;

FIG. 3 is a process flow diagram showing a method for server replication in the case of failures, in accordance with embodiments;

FIG. 4 is a process flow diagram showing a method for server replication and transaction commitment, in accordance with embodiments; and

FIG. 5 is a block diagram showing a tangible, computer-readable medium that stores a protocol adapted to direct a memnode to execute server replication and transaction commitment, in accordance with embodiments.

### DETAILED DESCRIPTION OF SPECIFIC EMBODIMENTS

A distributed transactional storage system is a distributed shared memory system that includes multiple computing nodes such that, if one node fails, the other nodes may still be able to continue functioning properly. A distributed system, such as a transactional shared memory system, provides high scalability, transactions, fast memory, and minimal network latencies during normal operation. The term “scalability” may refer to a system's ability to maintain or increase total throughput under an increased workload. This may be accomplished, for example, by the enlargement of the system through the addition of resources, typically hardware.

Many distributed systems achieve fault-tolerance in a primary-backup configuration for server nodes, which are memory nodes where all data is kept in memory. Unfortunately, the primary-backup approach relies on accurate failure detection in order to work correctly and, therefore, has diminished availability in the face of failures. For example, the system must ensure that the primary is dead before allowing operations to proceed with the backup. Resolving this failure can take tens of seconds to minutes, during which time some operations must simply wait.

Embodiments described herein provide techniques for server replication and transaction commitment in a distributed transactional storage system. Specifically, the current system and method provide a single protocol for both commitment of transactions and server replication in a distributed transactional storage system.

Distributed transactional storage provides both durability and availability. As used herein, the term “durability” means that, once data has been written to a storage system, it will remain there until it is overwritten. The availability feature of distributed transactional storage ensures that, if one server replica fails or goes offline, all other sever replicas may still operate and continue to provide the operations provided by the service, which may include both reading and writing the data. For example, the current system provides high availability because there is no primary node or backup node but, instead, all of the nodes operate on an equal level. The distributed system may function without interruptions if a quorum of nodes is functioning and accessible at any one time.

As used herein, a “transaction” is an atomic unit of work within a database management system that is consistent, isolated, and durable. As used herein, the term “atomic” refers to indivisibility and irreducibility. In other words, each transaction will have either complete success, or commitment, or complete failure. In the case of failure, the transaction will be aborted, and a rollback of the transaction will occur to ensure that the transaction will have no effect. Guaranteeing atomic transactions frees the programmer from concerns over partial updates occurring, which could lead to corruption of data or an errant view of the data.

In embodiments, a particular type of transaction which may be used in conjunction with the method described herein is a “minitransaction.” A minitransaction is a specific type of atomic transaction, in which the memory locations that will be accessed by the transaction are declared prior to starting the transaction. This type of transaction may be referred to as a static transaction. A minitransaction may include read items, write items, and comparison items that involve a number of pages within a memnode, wherein each page is a specific range of addresses in the address space of a single memnode. The decision to commit or abort a minitransaction may depend on the outcome of the comparisons corresponding to the comparison items. In another embodiment, the current system may be easily generalized to any other type of transaction, provided that the transaction can be prepared by the participating servers without any coordination. In other words, a value written at one server should not depend on a value written at another server within the same transaction.

In addition, transactions may be serialized, which means that, if multiple transactions are committed simultaneously, the transactions may be executed one after the other without intermingling. However, serializing transactions may limit the concurrency of the system. As used herein, the term “concurrency” refers to a property of systems in which several processes or transactions may be executed simultaneously and may potentially be interacting with each other. Therefore, in embodiments, while the system described herein may appear to execute transactions in a serial order, the system may not serialize the transactions at each server. This means that two transactions that do not access the same page may be executed in parallel, even if the two transactions touch the same server.

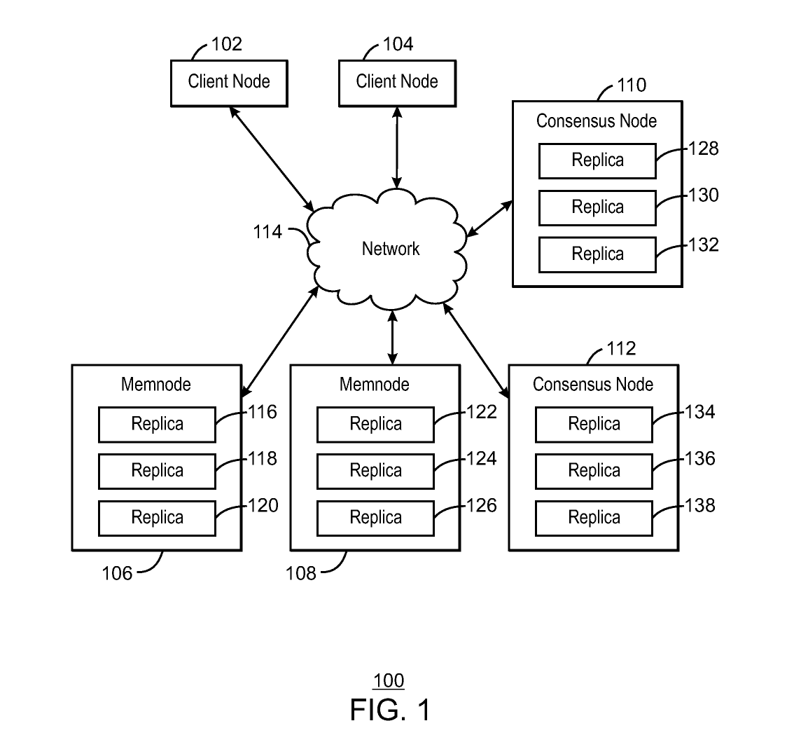

FIG. 1 is a block diagram of a server replication and transaction commitment system 100, in accordance with embodiments. As used herein, the term “node” refers to a device that is connected as part of a computer network or a record used to build linked data structures, such as linked lists, trees, and graphs. For example, a node may include a computer or a data field and other fields that form links to other nodes. The system 100 may consist of client nodes 102 and 104, memory nodes, referred to herein as “memnodes”, 106 and 108, and consensus nodes 110 and 112 interconnected through a network 114. The client nodes 102 and 104 may initiate transactions. The memnodes 106 and 108 may store the state acted on by transactions. The consensus nodes 110 and 112 may be used to record the outcome of a transaction, i.e., aborted or committed. The memnodes 106 and 108 may include a number of replicas. All of the replicas for one memnode constitute a replica group. In addition, a “replica” may be referred to simply as a “node,” since a replica may constitute a type of node contained within a memnode. In an embodiment, the set of replicas within one memnode may be referred to as a “virtual memnode” or “logical memnode.” In embodiments, the client nodes 102 and 104 may communicate directly with the individual replicas within the memnodes 106 and 108 and, thus, may be aware of the internal structure of a virtual memnode.

The system 100 provides for scalable performance by replicating partitions of the data storage independently, instead of replicating the state of the entire storage system, as discussed above. In addition, the system 100 may rely on main memory, which allows for much lower latencies. As discussed above, low latencies may be beneficial for modern-scale applications, which rely on quick reactions to changing conditions. Therefore, the distributed transactional storage described herein may operate completely in-memory, meaning that it utilizes only volatile or non-volatile main memory, with the exception that mass storage may be used for archival purposes. Moreover, in an embodiment, the consensus nodes 110 and 112 and the memnodes 106 and 108 may utilize different types of memory. For example, the memnodes 106 and 108 may run entirely in main memory, or may utilize disks in addition for archival or back-up. Similarly, the consensus nodes 110 and 112 may utilize a combination of main memory and disks.

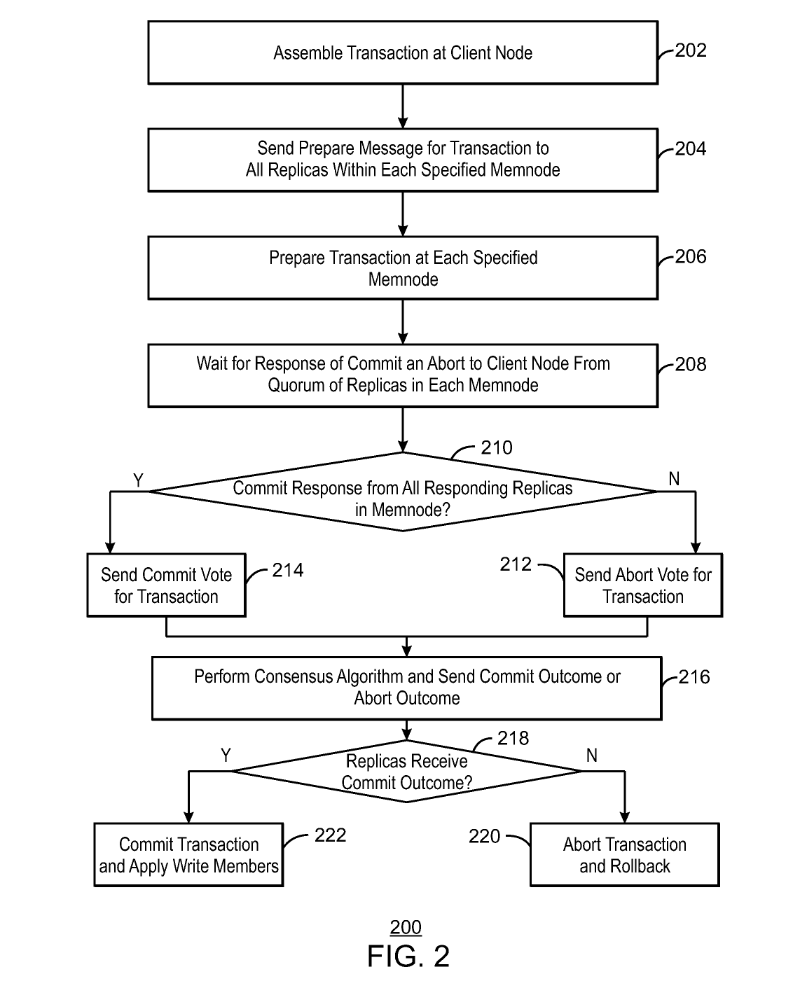

The client nodes 102 and 104 may include systems which are used by a human operator or by some software system. More specifically, client nodes 102 and 104 are systems which are capable of and intended for use in processing applications as may be desired by a user or by some software system. As used herein, the term “software system” refers to a set of non-transitory, computer-readable instructions that direct a processor to perform specific functions. The client nodes 102 and 104 may be commercially-available computer systems, such as desktop or laptop computers, or any other type of suitable computing device. In embodiments, the client nodes 102 and 104 may be referred to as “coordinators.” In addition, the system 100 may include any number of additional client nodes or may include only one client node, depending on the specific application. The client nodes 102 and 104 are discussed further with respect to FIG. 2.

The memnodes, or memory nodes, 106 and 108 may be attached devices providing random access memory (RAM) and/or disk space (for storage and as virtual RAM) and/or some other form of storage such as tapes, MEMS, optical disks, and the like. Memnodes 106 and 108 may also be commercially available computer systems, such as desktop or laptop systems, or other computer system providers. In addition, memnodes 106 and 108 may be specialized devices, such as network disk drives or disk drive arrays, high speed tape, MRAM systems or other devices, or any combinations thereof.

The memnodes 106 and 108 may also include logical units and may be used to ensure that the appropriate replicas are accessed for each transaction. The available memory within each memnode may be organized as a sequence of words. In an embodiment, each memnode 106 or 108 may provide a sequence of raw or uninterrupted words of a predetermined standard size, where each word consists of a certain bit array. For example, a word may contain eight, thirty-two, or sixty-four bits, or five hundred twelve bytes. In at least one embodiment, the words have eight bits. Moreover, in an embodiment, the words may be organized as address spaces, such as linear address spaces. In addition, within the system 100, data may be globally referenced by an address pair. For example, the address pair may be (mem-id, address), where “mem-id” is the identifier of a specific memnode and “address” is a number within the address space of the specific memnode. Further, it should be understood and appreciated that there may be multiple different ways to organize the address space for each memnode.

The memnodes 106 and 108 may be referred to as “servers” or “participants.” The memnodes 106 and 108 may be computers dedicated to serving programs running on other computers on the same network. The memnodes 106 and 108 may also be computer programs that serve other programs, or “clients,” which are on the same network and may or may not be on the same computer. In embodiments, the memnodes 106 and 108 may be software or hardware systems, such as database servers or file servers.

Moreover, the system 100 may include any number of additional memnodes or may include only one memnode, depending on the specific application. Additional memnodes may be desired to increase the amount of memory available to the client nodes, for example. Further, multiple memnodes may be stored within one computer system, or all memnodes may be located in separate computer systems and connected through the network 114.

The memnodes 106 and 108 may be used to store the state acted on by a transaction. Multiple replicas of a memnode may exist, which are collectively referred to as a replica group. For example, the replica group for memnode 106 may consist of replicas 116, 118, and 120, while the replica group for memnode 108 may consist of replicas 122, 124, and 126. Any number of additional replicas may be included in each replica group. In addition, each replica group may include different numbers of replicas.

In embodiments, as long as the memnodes 106 and 108 are connected to a network, they may be in a place that is not visible or easily-accessible. Further, the memnodes 106 and 108 may take many forms. As stated above, they may be non-volatile devices, disk arrays, or the like, but they may also be established as integrated circuits. Moreover, the memnodes 106 and 108 are understood and appreciated to be storage devices, which may be selected based on application preference and may then be provided to the client nodes 102 and 104 through the network 114.

The consensus nodes 110 and 112 may be attached devices providing random access memory (RAM) and/or disk space (for storage and as virtual RAM) and/or some other form of storage such as tapes, MEMS, optical disks, or the like. Consensus nodes 110 and 112 may also be commercially available computer systems, such as desktop or laptop systems, or other computer system providers. In addition, consensus nodes 110 and 112 may be specialized devices, such as network disk drives or disk drive arrays, high speed tape, MRAM systems or other devices, or any combinations thereof. The consensus nodes 110 and 112 may be used to determine and record the outcome of each transaction, i.e., whether a transaction was committed or aborted.

In embodiments, each consensus node 110 or 112 may include a number of replicas. For example, consensus node 110 may include replicas 128, 130, and 132, while consensus node 112 may include replicas 134, 136, and 138. The replicas may be used to determine whether a proposed outcome for a transaction from a client node 102 or 104 should be accepted or aborted. If a quorum of replicas for a particular consensus node 110 or 112 agrees to commit the transaction, the consensus node 110 or 112 may send a commit outcome message to the client node 102 or 104 in which the transaction originated.

Further, in some embodiments, the client nodes 102 and 104, memnodes 106 and 108, and consensus nodes 110 and 112 may be discrete elements logically or physically separated from one another. In other embodiments, any number of the client nodes 102 and 104, memnodes 106 and 108, and consensus nodes 110 and 112 may be physically co-located, such as in a rack or within the same system box.

Through the network 114, the nodes 102,104, 106, 108, 110, and 112 may exchange messages in order to complete a protocol for server replication and transaction commitment. For example, the client nodes 102 and 104 may send a prepare message for a minitransaction to the specified memnodes 106 and 108 through the network 114. The memnodes 106 and 108 may respond to the prepare message by sending a commit message or an abort message to the client nodes 102 and 104 through the network 114. The client nodes 102 and 104 may propose an outcome for the minitransaction by sending a propose message to the specified consensus nodes 110 and 112 through the network 114. The consensus nodes 110 and 112 may send a commit outcome or an abort outcome to the client nodes 102 and 104 through the network 114, and the client nodes 102 and 104 may send the outcome to the memnodes 106 and 108 through the network 114. The memnodes 106 and 108 may then commit or abort the minitransaction depending on the outcome message that was received. Network delays may occur for each time a node sends a message through the network 114. The protocol described herein may result in five network delays in the common case.

In embodiments, the system 100 may utilize a traditional network, such as a wired or wireless WAN or LAN operating at conventional speeds, or the system may utilize an optical fiber network to provide faster response times. However, in most cases, the latency of the network may not be a significant issue, and the transaction instruction set advantageously permits desired transactions to be collectively executed atomically. Moreover, the network 114 interconnecting the memnodes 106 and 108 and the client nodes 102 and 104 can be any medium, device, or mechanism that allows the nodes to communicate effectively. Further, the network 114 interconnecting the memnodes 106 and 108 and the client nodes 102 and 104 may not be homogeneous but, rather, may include multiple different types of networks. For example, one network may be established with a physical wire and another network may be established with radio transmission. Indeed, portions of the network or networks may have different bandwidths, latencies, packet sizes, access mechanisms, reliability protocols, and ordering guarantees.

In an embodiment, the system 100 may operate according to a protocol that enables transactional access to memory distributed over multiple servers and also ensure that the state of each server is replicated across multiple machines. The protocol uses a consensus algorithm executed by the consensus nodes to ensure that transaction commitment across multiple servers is atomic and non-blocking. In an embodiment, the protocol may utilize a plurality of independent instances of the consensus algorithm. As used herein, the term “non-blocking” refers to a system which enables transactions to be successfully completed even if one or more nodes becomes inoperable due to network delays or a failure of one or more system components. As used herein, the term “successfully completed” means that the transaction is driven forward to an abort or commit state. If the transaction is driven forward to an abort state, the transaction may be restarted automatically if the abort was caused by the failure of a memnode or the presence of a lock that interferes with the transaction commitment protocol, while the transaction may not be restarted if the comparison fails for other reasons. A non-blocking system deals with the failure of a server or node smoothly to avoid network delays that would otherwise be caused in a blocking system when a failure occurs in the system. In a blocking system, the user may be forced to wait for a response from the system for a long time, sometimes on the order of a thousand times longer than usual. The non-blocking nature of the protocol described herein is possible because there is no primary node or backup node, as discussed above. Rather, a proposed transaction can be committed if a quorum of replicas is operable and able to commit the transaction. Therefore, the system's availability may not be compromised by the failure of a single node in the system. As long as a quorum of the replicas is available, the system can function properly. The quorum size used to determine whether to commit a transaction may be any specified number of replicas or proportion of replicas in a replica group. In embodiments, the quorum may be a majority quorum. For example, if there are three replicas in a replica group the system may commit a transaction if two or more replicas are operational. However, if there are seven replicas in a replica group, the system may commit the transaction if four or more replicas are operational. However, other quorum systems may be used in accordance with embodiments, and different quorum sizes may be used for reading and writing data.

While existing protocols often utilize state-machine replication or two-phase commitment with primary-backup replication to replicate the state of a server, the current system utilizes independent instances of the consensus algorithm to replicate a transaction decision. In other words, the decision to commit or abort a transaction may be replicated using a consensus algorithm. The use of independent instances of a consensus algorithm allows for much easier implementation of the system and method described herein, as well as for greater concurrency, as compared to a system that uses Paxos state machine replication in the conventional way.

In an embodiment, the basic protocol that is followed by a consensus algorithm may involve client nodes 102 and 104 and consensus nodes 110 and 112, as discussed above. A client node 102 or 104 may propose an outcome for a transaction with a specified identification number. If multiple entities propose outcomes for the same transaction, the consensus node 110 or 112 selects one proposal and accepts the proposed outcome as the outcome of the transaction. For example, the consensus node may order all the proposals and accept the outcome proposed in the first proposal as the outcome of the transaction. If there is only one proposal, the consensus node may accept the outcome proposed by that proposal as the outcome of the transaction without waiting for additional proposals. Typically, the outcome decided by the consensus node for a transaction is one of the outcomes proposed for that transaction to the consensus node. Internally, the consensus node may execute a distributed protocol among its replicas to decide the outcome of a given transaction.

In an embodiment, the protocol described herein may utilize the Paxos consensus algorithm. The Paxos consensus algorithm is a type of protocol that may be used for recording an outcome of an agreement, or consensus, among multiple servers in a network or multiple server replicas within a server regarding transaction commitment. Consensus may often become difficult when a communication medium between multiple participants may experience failures. The Paxos consensus algorithm may rely on the interaction of multiple components that serve three roles: learners, acceptors, and proposers. A proposer is a transaction coordinator, and the value it proposes is the abort or commit decision for a transaction, which the coordinator determines based on the votes it collects from memnodes. A proposer may send its proposal to the acceptors. Each proposal in Paxos has a round or ballot number. The Paxos consensus algorithm relies on the agreement of a quorum of acceptors within a consensus node, or Paxos node. The acceptors function as the fault-tolerant memory of a Paxos node. The acceptors remember the outcome of a transaction in case a failure occurs and another coordinator may be launched to complete the transaction. In that case, the consensus service ensures that all coordinators for one transaction agree on the decision for that transaction. In example, the replicas in the consensus node 110 or 112 may serve as acceptors and learners. The client node 102 or 104 may serve as a proposer and a learner.

When the transaction coordinator sends a proposed decision to the acceptors, the decision may be accepted by a quorum of acceptors, which may notify the learners about the value accepted and the round number. The learners include the coordinators for the transaction. Once a quorum of acceptors accepts the same value in the same round, the Paxos consensus service is said to converge on that value. Once a learner receives notifications with the same round number form a quorum of acceptors, the learner knows that the Paxos consensus service has converged, and it also knows the decision for the transaction. If the decision is to abort the transaction, a rollback may be executed by a learner to ensure that the transaction does not take effect within the memnode. In an embodiment, one component of a system may perform all three roles, while, in another embodiment, any subset of the three roles may be performed by different components of a system, such as by three different systems. In another embodiment, a learner may be a proposer or one of a number of proposers. Further, it should be understood that the current system and method may utilize any type of consensus algorithm for the same purpose as that described above with respect to the Paxos consensus algorithm.

FIG. 2 is a process flow diagram showing a method 200 for transaction commitment, in accordance with embodiments. In addition, the method 200 provides for the replication of servers in a failure-free scenario. In other words, the commitment of transactions may result in the automatic replication of all of the replicas within a server, as long as all of the replicas are online and functioning properly.

The term “transaction commitment” refers to the agreement between multiple servers or systems to allow a transaction to proceed and not to abort the transaction. In other words, for every transaction, a decision may be made to either commit or abort the transaction. In an embodiment, this decision may be determined based on which participants vote to commit the transaction, and based on the evaluation of comparisons in the minitransaction. A consensus node may record the decision for a transaction to assist in recovery following a failure of the transaction coordinator, or one or more of the participants.

The method 200 begins at block 202 with the assembly of a transaction instruction set at a client node. The transaction instruction set stores information regarding the transaction, such as the particular functions (i.e., write, compare, or, read) to be performed by the transaction and the identity of the originating client node, or server. In embodiments, the particular type of transaction that is utilized in conjunction with method 200 may be a minitransaction. The transaction instruction set may include one or more subsets, including a write subset, a compare subset, a read subset, or any combinations thereof. Each subset in a transaction may include subset members that provide information used to execute the transaction, such as a memory node (or memnode) identifier, memory address range, write data, compare data, and the like. In embodiments, the memnode identifier may be determined from the memory address range.

In embodiments, the structure of the transaction instruction set may be pre-determined to provide a shell structure for a write subset, a compare subset, and a read subset, into which valid members are added. A non-valid member is one having null for the memory address and memory address range, which effectively results in an empty subset. In certain embodiments, use of the pre-defined shell structure may be advantageous in reducing overhead for the assembly of the transaction instruction subsets.

The client node may select the appropriate subset members for the transaction. A write subset member may be chosen, where the write subset member may include a valid memnode identifier, a memory address range, and write data. A compare subset member may be chosen, where the compare subset member may include a valid memnode identifier, a memory address range, and compare data. A read subset member may be chosen, where the read subset member may include a valid memnode identifier and a memory address range.

The transaction instruction set may include any suitable combination of subset members. For example, the transaction may include only write subset members, or a combination of write subset members, compare subset members, and read subset members, as well as other types of combinations. Moreover, the presence of a read subset member is not required to establish a valid transaction instruction set.

Once the transaction subset members have been determined, a decision of whether or not to add any additional transaction subset members to the transaction instruction set may be made. If additional transaction subset members are desired, the assembly of the transaction at the client node continues. Otherwise, the method proceeds to block 204.

At block 204, the client node may send a prepare message for the transaction to all replicas within each specified memnode. The prepare message may be as follows:

PREPARE_REQ(TID, S, R, C, W, readOnly),

where TID=the transaction identification (ID) number, S=the set of memnodes involved in the transaction, R=read items at the recipient memnode, C=compare items at the recipient memnode, W=write items at the recipient memnode, and readOnly=a Boolean flag that is true if and only if the transaction has no write items. The prepare message may be used to initiate the preparation of a transaction at a memnode.

At block 206, the transaction may be prepared at each specified memnode. Each memnode may attempt to acquire locks on all pages involved in the transaction. The integrity of the locks may be accessed to determine whether all specified memory address ranges have been locked at each specified memnode. If the locks are determined to be unsuccessful, a negative lock message may be returned.

If the locks are determined to be successful, the replicas within the memnode may proceed with the preparation of the transaction by computing the version numbers of all locked pages. In addition, the replicas may compute the values of all read members specified by the transaction instruction set. In addition, any compare members specified by the transaction may be executed. A determination of whether the compare was successful may be made. If the compare is negative, a negative compare message may be returned by the replicas. If the compare is positive, a positive compare message may be returned by the replicas at block.

At block 208, the client node may wait for a commit response or an abort response from at least a quorum of the replicas in each memnode. A determination of whether all responding replicas sent an identical commit response may be made at block 210. The response from the server replicas to the client node may be as follows:

PREPARE_RSP(TID, vote, R′, V),

where vote=COMMIT or ABORT, R′=the values of the read items if the vote=COMMIT or undefined if the vote=ABORT, and V=the version numbers of all locked pages if the vote=COMMIT or undefined if the vote=ABORT.

If any of the responding replicas send an abort response to the client node, the client node may send a proposed abort vote for the transaction to the consensus node at block 212. However, if all of the responding replicas send a commit response to the client node, or if a quorum of the replicas within each participating memnode sends a commit response to the client node, the client node may propose a commit outcome for the transaction to the consensus node at block 214. In an embodiment, when the Paxos consensus procedure is utilized for consensus, the client may communicate with the acceptors directly. Thus, the propose request from client to consensus node may take the form of separate messages to the Paxos acceptors, and the propose response may be separate messages from the acceptors to the client, or learner. The proposed abort or commit vote may be as follows:

PROPOSE_REQ(TID, S, outcome),

where outcome=COMMITTED or ABORTED. If the client node sends a proposed commit vote to the consensus node at block 214, the values of all read members may be computed at the client node using the replica responses.

Once the consensus node has received the propose message from the client node, the consensus node may initiate an instance of a consensus algorithm in order to make a decision of whether to return a commit outcome or an abort outcome to the client node. At block 216, the consensus node may send a commit outcome or an abort outcome to the client node. The outcome response that is sent from the consensus node to the client node once the consensus algorithm has converged may be as follows:

PROPOSE_RSP(TID, outcome′),

where outcome′=a commit outcome or an abort outcome, depending on the outcome agreed upon by the consensus node for each particular instance. In addition, if the consensus node does not converge within a specified period of time, the client node may send a status query message to the consensus node to ask for the outcome of the transaction. The status query message may be as follows:

QUERYSTATUS_REQ(TID).

Once the consensus node has checked the status of the transaction, it may send a response back to the client node, where the response may be as follows:

QUERYSTATUS_RSP(TID, outcome),

where outcome=COMMITTED, ABORTED, or UNKNOWN. The client node may send another QUERYSTATUS_REQ request to the consensus node if the outcome of the transaction is unknown or unconfirmed.

Once the client node receives the outcome from the consensus node, the outcome may be sent to the replicas within each memnode. A determination of whether the replicas received a commit outcome from the client node may be made at block 218. If the replicas have received an abort outcome instead of a commit outcome, the transaction may be rolled back at block 220 to ensure that the transaction does not change the state of the memnode. The abort outcome message that is sent from the client node to the replicas may be as follows:

ABORT_REQ(TID).

The abort outcome message may inform the replicas to perform a complete rollback of the transaction. In order to complete the rollback of the transaction, the replicas may undo any changes within the replica itself that were caused by the transaction commitment procedure.

However, if a commit outcome is received from the client node, the transaction may be committed at block 222. Commitment of the transaction causes the replicas to perform all of the functions specified by the particular transaction. Specifically, the locks on the pages touched by the transaction may be released and any write members specified by the transaction may be applied at each memnode. The commit outcome message that is sent from the client node to the replicas may be as follows:

COMMIT_REQ(TID).

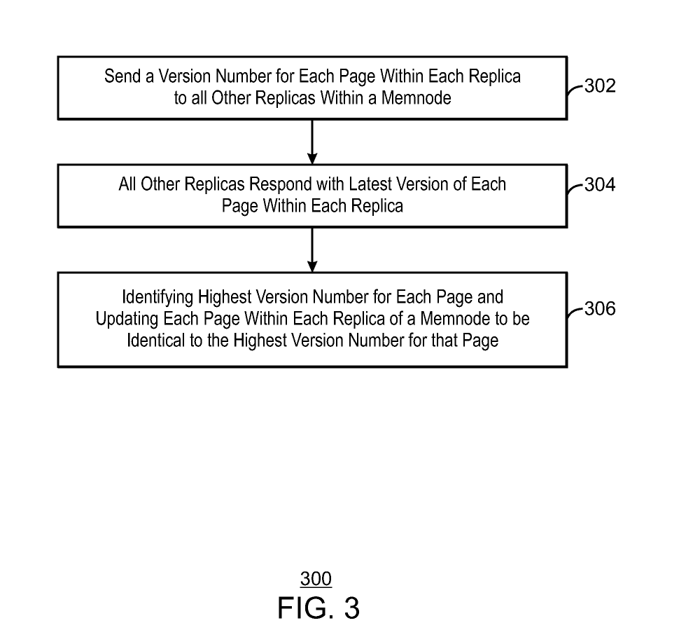

The commit outcome message may inform the replicas to proceed to complete the transaction in its entirety. In addition, once the transaction is committed, any pages that were modified by the transaction may update their page version numbers and contents. In an embodiment, the page version number may be increased by one each time a page is modified. In the case of the failure of one or more replicas within a memnode, the page version numbers may then be utilized by the server replication method 300, as discussed with respect to FIG. 3.

In an embodiment, the method 200 may be modified such that, if a read-only transaction is specified by the client node, i.e. if a transaction involves read members but no write or compare members, the client node may not communicate with the consensus node at all. Instead, the client node may make an independent decision regarding the outcome of the transaction and directly order the replicas within each specified memnode to release the locks on the relevant pages. For this embodiment, the protocol operates much more quickly, and the number of network delays is reduced from five to three, since the proposed outcome message from the client node to the consensus node and the confirmed outcome message from the consensus node to the client node may not be sent over the network.

According to method 200, the client node may proceed to initiate a consensus algorithm at the consensus node once a quorum of the replicas at each participating memnode has sent a response to the client node. However, in an embodiment, if additional replicas respond to the client node at some later time, and the consensus algorithm has not converged yet, it may render the consensus algorithm unnecessary. Thus, the client node may accelerate the commit process by abandoning the instance of the consensus algorithm that was triggered and directly ordering the replicas to commit or abort the transaction. This may reduce the number of network delays from five to four, since the outcome message from the consensus node to the client may not be sent over the network.

Further, in another embodiment, one network delay could be deleted from the method 200, resulting in four network delays, by allowing the replicas within a memnode to respond directly to the acceptors within a Paxos node. This may accelerate the protocol because, in the common case, the replica responses are sent from the memnode to the client node and then from the client node to the Paxos node. In addition, the number of network delays may be further reduced by having the replicas not only respond directly to the acceptors, but also having the acceptors respond back to the replicas directly in parallel with their response to the client. Therefore, the use of this mechanism may result in only three network delays. Further, in this embodiment, the memnode may function as both a proposer and a learner.

In another embodiment, a client node may read data from one or more memnodes by accessing only one replica at each memnode. For example, a client node reading data on a memnode may do so by reading directly from a replica, bypassing the transaction commitment protocol discussed with respect to method 200. Unless the size of a read quorum at a memnode equals one, reading data in this way does not guarantee serializability. In other words, the data read may be stale, and reading from multiple memnodes may not guarantee atomicity. However, because each read includes only two messages and two network delays, this technique may improve performance in applications that can tolerate inconsistent data.

In yet another embodiment, a reaper process may be used to periodically check for stalled transactions and attempt to complete them. For each stalled transaction, the reaper may communicate with the replicas for each memnode that is specified by the particular transaction in order to determine the appropriate outcome of the transaction. If, for each memnode involved, all of the replicas of that memnode are operable and agree on their vote to abort or commit the transaction, the reaper may drive the transaction forward to completion. In that case, the reaper may commit the transaction if all replicas within all of the memnodes involved in the transaction vote to commit. However, if any of the replicas within any of the memnodes vote to abort, the reaper may abort the transaction. On the other hand, if the replicas are out of sync, i.e., if some replicas do not agree that the transaction should commit, the reaper may rely on the consensus node, which may initiate the consensus algorithm to determine whether the transaction should commit or abort. In this case, the reaper may initially send a proposed abort vote to the consensus node. Once the consensus algorithm has converged, the consensus node may send the appropriate outcome to the reaper. The reaper may then abort or commit the transaction, depending on the outcome. It should be noted that the reaper may be included within the client nodes, memnodes, or consensus nodes, or may be physically separated from the nodes and connected through the network.

FIG. 3 is a process flow diagram showing a method 300 for server replication in the case of failures, in accordance with embodiments. Method 300 may be useful for cases in which any of the replicas within a memnode failed to update the pages affected by a transaction due to unavailability, such as in the case of network or power failures. Server replication is the process of copying and distributing data or database objects from one database to another and synchronizing databases to maintain consistency between multiple databases. The distribution and synchronization of data or database objects may be implemented using a local area network (LAN), wide area network (WAN), dial-up connection, wireless connection, or the Internet. In addition, for server-to-server replication, the data or database objects may be updated as transactions are being committed. In other words, the replication system may operate on a transaction-by-transaction basis.

The method 300 may be executed at the same time as the method 200 in order to provide a fast system for simultaneously committing or aborting transactions at a memnode and updating the replicas within the memnode. In addition, according to method 200 and 300, all of the replicas within a memnode may communicate with one another in order to ensure consistency within the memnode.

At block 302, a replica may send a version number for one of more of the pages within the replica to all other replicas within a particular memnode. A replica may announce the version numbers for its own pages by sending the following announcement message:

PAGESOFFER_REQ(V),

where V=the version numbers of pages stored within the replica.

At block 304, all other replicas within the same memnode may respond to the message at block 302 by sending the latest version numbers for each page within each replica to all replicas within the memnode. The replicas may respond with the same announcement message as discussed above with respect to block 302.

At block 306, the highest version number for each corresponding page within the memnode may be determined, and each page may be updated within each replica in order to ensure that all replicas contain the latest version for each page. For each page, the replica containing the highest version number for the page may transfer the page to all other replicas within the memnode. This may be accomplished by sending the following request message from each replica to the replica containing the highest version number for a page:

PAGEASK_REQ(PageNums),

where PageNums=the requested highest version page number(s). The replica containing the highest version number for the requested page(s) may then respond by transferring the highest version number page(s) to all other replicas, as specified by the following message:

PAGEASK_RSP(Pages),

where Pages=the page or set of pages with the highest version number.

It should be understood that FIGS. 2 and 3 are not intended to indicate that the steps of methods 200 and 300, respectively, must be executed in any particular order. In addition, any number of the steps of methods 200 and 300 may be deleted, and any number of additional steps may be added, depending on the specific application. Further, it should be understood that other types of transactions, including static transactions such as minitransaction, may be utilized in conjunction with methods 200 and 300.

In an embodiment, the method 300 for server replication allows for quick and easy crash recovery, since an individual replica within a memnode may simply pull the latest version of each page from the other replicas within the same memnode. In addition, since the transaction commitment system may function properly if a quorum of the replicas within a server is available at any point in time, the permanent failure of a replica may not affect the overall performance of the system.

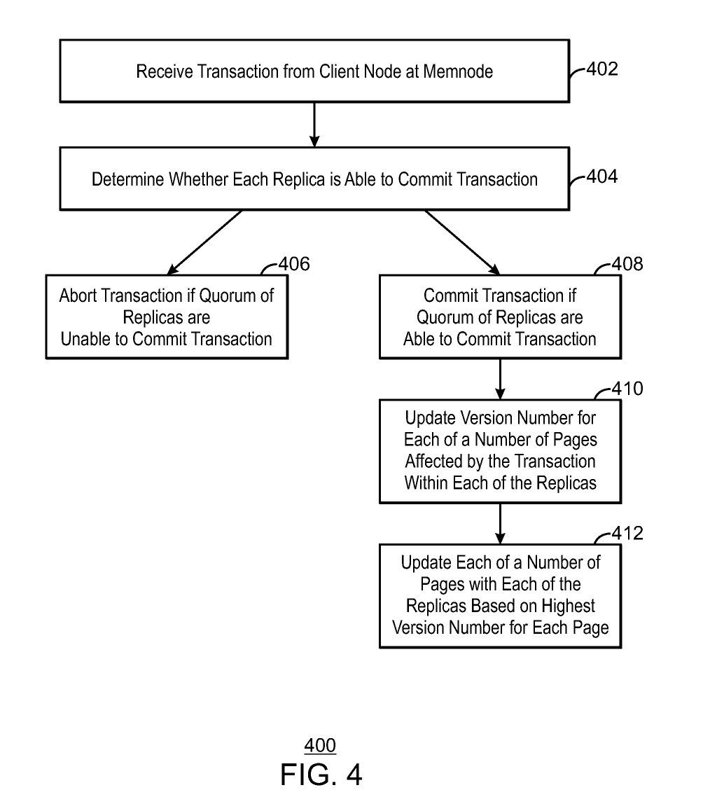

FIG. 4 is a process flow diagram summarizing a method 400 for server replication and transaction commitment, in accordance with embodiments. At block 402, a memnode may receive a transaction from a client node. The memnode may include a number of replicas. The state of each memnode, or server, may consist of a set of pages of fixed size, each with a page version number. Within each server replica, each page may be tagged with a page version number, wherein the page version number may be zero initially. The page version may increase or decrease monotonically each time the page is modified by a transaction. In embodiments, the page version numbers may be chosen in any manner as long as a page does not have the same page version number more than once. In addition, there is a lock for each page to facilitate transaction commitment.

At block 404, a determination may be made about whether each replica within the memnode is able to commit the transaction. The memnode may then send a response to the client node or directly to a consensus node, where the response from the memnode may consist of a response from each of a number of replicas within the memnode. The client node or consensus node may wait for a response from at least a quorum of the replicas within each of one or more memnodes. Moreover, the consensus node may be configured to receive and record the responses from each of the replicas within the memode.

At block 406, the memnode may abort the transaction if, for one or more memnodes involved, no quorum of the replicas is able to commit the transaction. The decision to abort the transaction may involve the consensus node. For example, the consensus node may decide on an abort outcome for the transaction if a quorum of the replicas at each memnode does not vote to commit the transaction. If the transaction is aborted, the memnode may roll back the transaction to erase any changes that may have been made to the memnode by the transaction during the transaction commitment method. In addition, the client node may also abort the transaction if no quorum of the replicas is online or properly functioning.

At block 408, the memnode may commit the transaction if a quorum of the replicas within each of the one or more memnodes is able to commit the transaction. The decision to commit the transaction may involve the consensus node. For example, the consensus node may decide on a commit outcome for the transaction if a quorum of the replicas at each memnode votes to commit. The client node may assist each memnode by informing the memnode about whether the other memnodes have voted to commit the transaction. If the transaction is committed, the memnode may complete the transaction in its entirety by performing any read from, write to, or compare members specified by the specific transaction instruction set. In the case of the failure of one or more replicas within a memnode, the method 400 may continue to block 410. The steps at blocks 410 and 412 may ensure that all replicas within a memnode maintain consistency by confirming that all of the replicas contain the highest version numbers for each page.

At block 410, once the transaction has been committed, the memnode may update the version number for each of the pages affected by the transaction within each of the replicas. Each replica within a memnode may then send a version number for each of its pages to every other replica within the same memnode. The replicas may then complete a comparison of the version numbers for each corresponding page and determine which replica has the latest, highest version number for each page.

At block 412, the pages within each replica may be updated based on the highest version number for each page. This may ensure that the replicas within a memnode remain consistent with one another and that all replicas contain the most recently updated versions of each page. In embodiments, the replication of individual pages within a memnode on a case-by-case basis provides for a highly efficient and consistent system.

In an embodiment, the steps at blocks 402, 404, 406, and 408 may be executed separately from the steps at blocks 410 and 412. The steps at blocks 402, 404, 406, and 408 may be treated as an independent method for transaction commitment, as well as server replication in the failure-free case, while the steps at blocks 410 and 412 may be treated as an independent method for server replication in the case of the failure of one or more replicas within a memnode. In embodiments, blocks 410 and 412 may also be executed in parallel. In addition, the methods for transaction commitment and server replication in the case of failures may be executed in parallel with one another using the server replication and transaction commitment system 100.

In embodiments, the transaction commitment method and the server replication method may operate in parallel in order to maintain consistency throughout the memnode. For example, if a transaction modifies certain pages within a number of the replicas, the server replication method may ensure that the modified pages are updated within all of the replicas in the memnode, including the replicas which were not involved in the particular instance of the transaction commitment protocol. Moreover, in embodiments, the server replication protocol may operate continuously, while the transaction commitment protocol may only be initiated in response to the requests of a user at a client node.

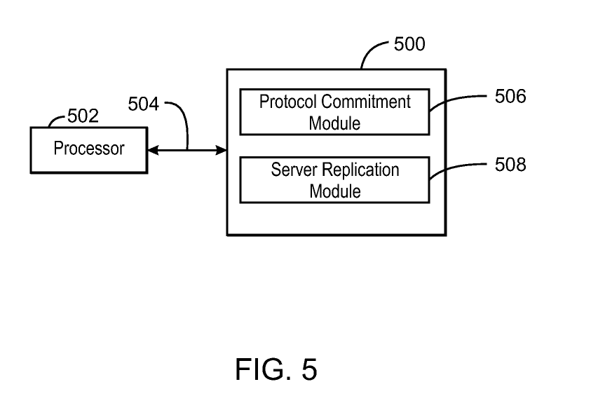

FIG. 5 is a block diagram showing a tangible, non-transitory computer-readable medium 500 that stores a protocol adapted to direct a memnode to execute server replication and transaction commitment, in accordance with embodiments. The protocol integrates in-memory state replication with non-blocking transaction commitment in a transactional storage. The tangible, non-transitory computer-readable medium 500 may be accessed by a processor 502 over a computer bus 504. Furthermore, the tangible, non-transitory computer-readable medium 500 may include code to direct the processor 502 to perform the steps of the current method.

The various software components discussed herein may be stored on the tangible, non-transitory computer-readable medium, as indicated in FIG. 5. For example, a transaction commitment module 506 may be adapted to direct the processor 502 to perform the steps of the transaction commitment protocol, as discussed with respect to FIG. 2. In addition, a server replication module 508 may be adapted to direct the processor 502 to perform the steps of the sever replication protocol, as discussed with respect to FIG. 3.

While the present techniques may be susceptible to various modifications and alternative forms, the exemplary embodiments discussed above have been shown only by way of example. It should be understood that the technique is not intended to be limited to the particular embodiments disclosed herein. Indeed, the present techniques include all alternatives, modifications, and equivalents falling within the true spirit and scope of the appended claims.

What is claimed is:

1. A method, comprising:
receiving a transaction from a client node at one or more memory nodes, each memory node comprising a plurality of replicas;
determining, for each one of the plurality of replicas, whether the replica is able to commit the transaction;
sending a response from each one of the plurality of replicas to a consensus node, wherein the consensus node is configured to record whether the response is a commit response;
committing the transaction if, at each memory node, a quorum of the replicas is able to commit the transaction; and
aborting the transaction otherwise.

2. The method of claim 1, wherein the transaction comprises a minitransaction, and wherein the minitransaction comprises a type of transaction which atomically executes any combination of reading, comparing, and writing to any of a plurality of memory locations.

3. The method of claim 1, further comprising, if the transaction is committed:
updating a version number for each of a plurality of pages affected by the transaction within each of the plurality of replicas; and
updating each of the plurality of pages within each of the plurality of replicas based on a highest version number for each of the plurality of pages.

4. The method of claim 1, wherein receiving a transaction from a client node at a memory node comprises receiving a prepare message for the transaction.

5. The method of claim 1, wherein determining, for each one of the plurality of replicas, whether the replica is able to commit the transaction comprises sending a commit message or an abort message from any number of the plurality of replicas to the client node.

6. The method of claim 1, wherein committing the transaction comprises receiving a commit outcome from the client node or the consensus node if a quorum of the plurality of replicas within each memory node is able to commit the transaction.

7. The method of claim 1, comprising aborting the transaction if, for at least one of the one or more memory nodes, no quorum of replicas is able to commit the transaction.

8. The method of claim 7, wherein aborting the transaction comprises performing a rollback of the transaction.

9. A system, comprising:
a client node configured to generate a transaction and send the transaction to one or more memory nodes, each memory node comprising an address space of shared memory and a plurality of replicas; and
the one or more memory nodes configured to receive the transaction from the client node, wherein each one of the plurality of replicas is configured to generate a commit vote if the replica is able to commit the transaction and to send the commit vote to a consensus node;
wherein, if a quorum of the plurality of replicas at each memory node is able to commit the transaction, each of the memory nodes receives a commit command that causes at least the quorum of the plurality of replicas to commit the transaction.

10. The system of claim 9, wherein the consensus node is configured to receive and record commit votes from the plurality of replicas.

11. The system of claim 9, wherein the memory node is further configured to:
update a version number for each of a plurality of pages affected by the transaction within each of the plurality of replicas; and
update each of the plurality of pages within each of the plurality of replicas based on a highest version number for each of the plurality of pages.

12. The system of claim 9, wherein the system comprises a distributed system of a plurality of client nodes, a plurality of memory nodes, and a plurality of consensus nodes interconnected through a network.

13. The system of claim 9, wherein the transaction comprises a transaction instruction set, comprising at least one of:
a write subset having at least one write member, wherein the write member comprises a memory node identifier, a memory address, and write data;
a compare subset having at least one compare member, wherein the compare member comprises a memory node identifier, a memory address range, and compare data;
a read subset having at least one read member, comprising a memory node identifier and a memory address range; or
any combination of the write subset, the compare subset, and the read subset.

14. The system of claim 11, wherein the transaction may utilize any of the plurality of pages within any of the plurality of replicas.

15. The system of claim 14, wherein any of the plurality of pages that are utilized by the transaction are locked or unlocked by the plurality of replicas based on an outcome of the transaction.

16. The system of claim 9, wherein the system further comprises a reaper to check for stalled transactions and to attempt to complete the stalled transactions.

17. The system of claim 9, wherein, if the transaction comprises a read-only transaction that operates on a single memory node, the client node may automatically commit the transaction without determining whether the quorum of the plurality of replicas is able to commit.

18. The system of claim 9, wherein, if the transaction comprises a read-only transaction, the client node may read data directly from less than the quorum of the plurality of replicas at each memory node.

19. A tangible, non-transitory computer-readable medium that stores a protocol adapted to execute server replication and transaction commitment within a memory node, wherein the protocol comprises instructions to direct a processor to:
receive a transaction from a client node at the memory node, the memory node comprising a plurality of replicas;
determine, for each one of the plurality of replicas, whether the replica is able to commit the transaction;
vote to commit the transaction if a quorum of the replicas at the memory node is able to commit the transaction;
vote to abort the transaction otherwise;
send a vote for the transaction to a consensus node, wherein the consensus node is configured to receive and record the vote; and
commit the transaction if all of a plurality of memory nodes involved in the transaction vote to commit the transaction.

20. The tangible, non-transitory computer-readable medium of claim 19, wherein the protocol comprises further instructions to direct the processor to:
update a version number for each of a plurality of pages affected by the transaction within each of the plurality of replicas; and
update each of the plurality of pages within each of the plurality of replicas based on a highest version number for each of the plurality of pages.
